(19) United States
(12) Patent Application Publication
(10) Pub. No.: US 2020/0128792 A1
(43) Pub. Date: Apr. 30, 2020

(54) NON-INVASIVE DEVICE FOR REMOTELY CONTROLLING AND STOPPING EITHER QUADRUPEDS OR BIPEDS FOR SAFETY AND TRAINING PURPOSES

(71) Applicant: Claudio TOVORNIK, Caerano San Marco (IT)

(72) Inventor: Claudio TOVORNIK, Caerano San Marco (IT)

(21) Appl. No.: 16/624,581

(22) PCT Filed: Jun. 18, 2018
(86) PCT No.: PCT/IT2018/050109

§ 371 Date: Dec. 19, 2019

(30) Foreign Application Priority Data
Jun. 23, 2017 (IT) 102017000068995

(51) Int. Cl. A01K 15/04; A01K 27/00; A01K 15/02

(52) U.S. Cl. CPC A01K 15/04; A01K 15/021; A01K 27/009; A01K 27/002

(57) ABSTRACT

This invention can be preferably adopted in the sector of the accessories for pets, particularly in the sector of leashes, collars, harnesses and of systems for controlling and stopping quadrupeds and/or bipeds.

### PURPOSE OF THE INVENTION

This invention can be preferably adopted in the sector of the accessories for pets, particularly in the sector of leashes, collars, harnesses and of systems for controlling and stopping quadrupeds and/or bipeds.

### DESCRIPTION OF THE STATE OF THE ART

The state of the art shows known solutions for controlling animals: for example, should an owner want to let his animal free, but avoid that the animal escapes, not obeying verbal orders, document DE202004011942 describes an electric collar equipped with a series of electrodes in contact with the animal's throat. The owner can stimulate electrical shocks to the animal's throat to control his dog's behavior.

Document U.S. Pat. No. 4,919,082 describes a system where a band, put on the dog's throat, can be remotely tightened or loosened by the owner on the animal's throat, thanks to an electromechanical motor put into a stiff case connected to the collar and interacting with it.

The systems previously described involve an increased risk of animal's injuries and psychophysical malaises, besides not assuring its immobilization.

Document U.S. Pat. No. 8,726,844 describes a further system for limiting the animal's movement: the document describes a flexible control panel that however shows the disadvantage not to be reversible on command, as the flexible panel has to be manually bent again. Furthermore, should the dog be quickly running, it could be subjected to a violent fall due to the device activation.

The solution described in document DE10210047219 considers the blowing up of a cushion by means of a gas cartridge (CO2) at high pressure; such a system proves not to be very handy as it has the disadvantage to be barely reversible as it needs the cushion deflation. Moreover it puts the animal in contact with a high pressure gas spray can, to be replaced or recharged if need be.

Other devices for controlling the movement of a quadruped are the harnesses described in documents DE102006010838, WO9951088, U.S. Pat. No. 4,528,944, US2010242861, GB2480061, AU644431, U.S. Pat. No. 3,994,264, US2011297105, U.S. Pat. No. 9,497,933.

All devices described in the above mentioned documents, act by forcing the possibility of the limbs movement, particularly the one of the rear limbs, and have the disadvantages to be expensive in construction and heavy.

Moreover the state of the art previously mentioned involves the use of a series of belts to be adjusted and closed when putting the harness on the animal. Therefore these solutions prove to be bulkier, more difficult to be bent again and therefore more difficult to be carried.

Finally the cords that determine the running control, are easily accessible to the animal's bite, that could damage them or alter their arrangement.

The purpose of the invention relative to this patent application is to overcome the above described limits of the state of the art, by realizing a non-bulky device that can assure the complete stop, particularly through a solution of transverse approach and control of the animal's front paws, causing this way a progressive slowing down till the complete stop.

The invention relative to this patent application is illustrated as an example and not for limitation in the Charts herewith enclosed, in which:
100: Central unit
300: Starting up device
101: Pulling device
102: Actuating device
103: Receiving system
104: Power supply unit
105: Holes for pulling cord passage
106: Fastening points of the central unit to the collar or to the harness
108: Pulling cord
109: Left closed circular segment
110: Right closed circular segment
111: Single round element
200: Support elements
201: Harness
202: Collar
203: Dorsal belt

### INVENTION DESCRIPTION

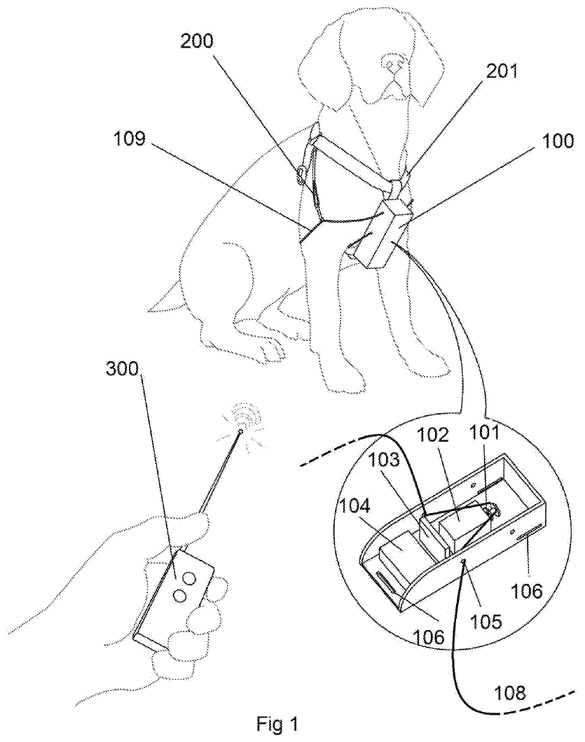

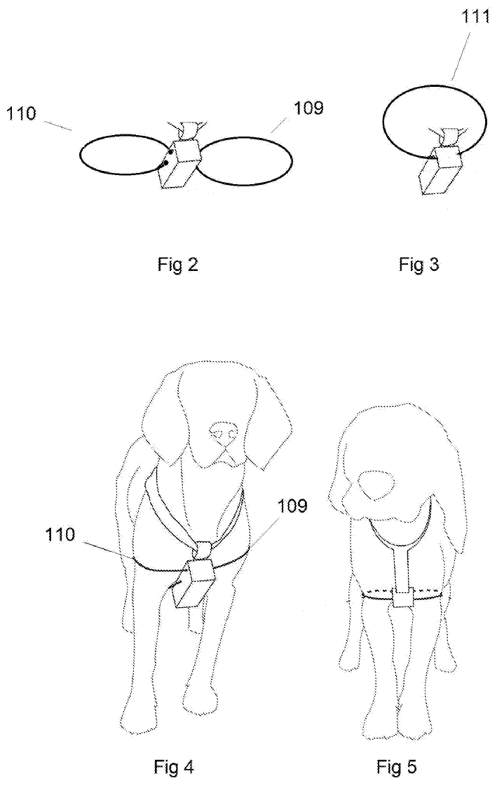

With reference to the enclosed charts, the invention relative to this patent application consists of a central unit (100) called central unit (100) made up of a case that accommodates at least an actuating device (102), at least a pulling device (101) to which is connected a cord (108) that, externally the device, presents itself in the form of two closed circular segments, right and left (110, 109 FIG. 2) or of a single closed round segment (111 FIG. 3).

The cord (108) then passes the case of the central unit (100) through general holes (105) present in the same case.

With reference to the enclosed figures, the cord (108) is internally connected to the pulling device (101) that in turn is connected to the actuating device (102).

Moreover the central unit (100) has inside at least a power supply unit (104) and at least a receiving system (103).

Moreover the case of the central unit (100) shows at least a fastening point (106) to the collar (202) or to the harness (201).

### DESCRIPTION OF THE INVENTION FUNCTIONING

The central unit (100), if need be, can be therefore connected to a general harness (201) or to a collar (202) or to a dorsal belt (203); particularly, with illustrative but not limitative reference to the enclosed Charts, the central unit (100), realized as previously described, can be fastened to the harness (201) through some support elements (200), preferably but not exclusively of material with elastic properties, or connected to a dorsal belt (203), preferably but not exclusively of material with elastic properties.

The two right and left closed circular segments (110, 109) or the single closed circular segment (111), placed outside the case of the central unit (100) are passed through the animal's paws and brought to the height of the shoulders.

By means of a starting up device (300), preferably but not exclusively of the transmitting type, the actuator (102) is activated, producing this way the activation of the pulling device (101) that acts on the cord (108) causing, depending on the imposed movement, the lengthening or the shortening of the outside circular segments (109,110) or of the closed circular segment (111).

As the cord (108) is connected to the animal's front paws, through its closed circular segments (109, 110) or through the single closed circular segment (111), the shortening or the unwrapping causes the approach or the release of the animal's front paws.

As an example but not exclusively and without modifying the above mentioned characteristics, the pulling device (101) can consist of a pulley, or an elastic element such as a spring, or a pneumatic element.

As an example but not exclusively and without modifying the above mentioned characteristics, the actuator (102) can consist of a motor or a general electromechanical actuator or an electromechanical valve.

As an example but not exclusively and without modifying the above mentioned characteristics, the cord (108) can consist of a wire, or a ribbon, or a linear element of metallic material, or a linear element of any other kind of material.

As an example, the starting up device (300) can be equipped with three pushbuttons: a first button will command the wrapping of the cord (108), and therefore the narrowing of elements 109 and 110 or 111, causing the pull on the animal's shoulders/paws with stop of the limbs; a second button will cause the stop of the cord (108) movement and of the animal, and a third button will cause the cord (108) unwrapping on the pulling system (101) allowing the animal's release.

In the position in which the cord (108) is completely released (FIG. 4), the paws keep the whole freedom of movement, and can both run and jump.

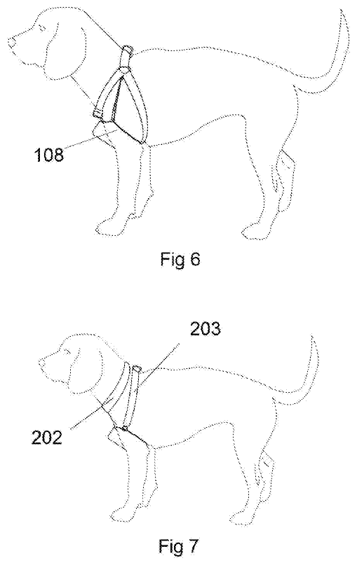

A progressive cord shortening (FIG. 5) will cause the approach of the front limbs progressively limiting their freedom, slowing down the animal's running and a further shortening will cause the animal's complete stop.

In order to avoid that the paws are excessively tight, the system can be equipped with force automatic limiting elements, for example frictions, or loading electronic regulators, adjustable based on the animal's height.

The system realized according to the above descriptions enables the animal's owner to condition the animal's freedom based on his will, for safety and training purposes.

The central unit (100), lengthways leant against the animal's chest, can be fastened to it in various ways, preferably according to the following options:

The system can be equipped with lateral (elastic) supports that keep in position the animal's paws blocking cord/band.

The invention relative to this patent application and realized as described, can provide for the starting up device (300) to act even if in absence of manual command, therefore also in automatic modality, providing for suitable activation means.

For example the starting up device (300) can be connected both to the animal, by means of the central unit (100), and to the leash, in order to verify a possible disconnection harness and/or collar from the leash and instantly activate the device, immobilizing so the animal in order to prevent its escape. In another preferential way it is possible to provide for the addition of a positioning system (GPS) or of a bidirectional radio communication system and, in case of moving away beyond a certain range and/or in case of loss of the radio control signal, the system can automatically immobilize the animal, always in order to prevent the animal's loss.

Moreover, it is possible to provide for the use of a proximity sensor in order to measure the correct insertion of the limbs inside the harness composed of the two loops S and S′.

Moreover, it is possible to supply the animal with one or more sound signals, by adding a sonorous generator inside the central unit (100).

A warning sound signal could discourage the animal from keeping escaping, actually before activating the limbs constraint. Moreover, should the animal be immobilized in a hidden area, a sound signal will help the user trace the animal. A sound signal could lastly be useful to third persons to understand the emergency state relative to the animal's stop.

The system realized as per above descriptions is therefore:
adaptable to the animal's build and weight and, operating in a gradual way,
painless and respectful of the animal,
easily and remotely reversible.

Moreover, as previously described, the system can be also applied to a normal collar or harness, the device has reduced amount of space and weight, so much so that it can be put into a pocket-sized case. The geometry of the set is very simple: it provides cords, which length and diameter are contained, and few harness belts: this also make it easier to put it on.

Another advantage is the possibility of fast hooking and unhooking either from the collar or from the support harness, allowing the animal to constantly remain tied, also during the application, to a simple and traditional leash.

The aim of this invention is therefore to avoid that quadrupeds and bipeds escape or disobey orders, giving this way a control sensation and psychological tranquility to the animal's owner.

It is also possible to avoid that an animal dangerously move closer to streets, vehicles, railways, water, electrical systems, defenseless persons, or to other animals, causing possible inconveniences or very dangerous situations either for itself or for other involved persons/animals.

Short immobilization periods, that anyway don't cause any pain, will dissuade the animal from carrying out any dangerous or forbidden operations and movements. This invention is therefore suited to be used as a training means, by training an animal to respond to orders and to the respect of limitations.

Uncontrolled sound disturbances caused by a motiveless and continuous animal's call can be limited by means of a short activation of the device, with a deterrent effect.

On occasion of physical assaults and uncontrolled aggression, a limiting and training action can be carried out by temporarily using the above device.

1. Non-invasive device for remotely controlling and stopping either quadrupeds or bipeds for safety and training purposes, said device connectable to a collar (202) or to a harness (201) of the quadruped or biped, said device comprising:
a central unit (100) comprising at least an actuator (102),
at least a receiving system (103),
a cord (108) connected to a pulling device (101), said pulling device (101) being housed inside the central unit (100) and connected to the actuator (102), wherein:
the cord (108) passes through the central unit (100);
the cord (108) is composed of a single continuous element without a break;
the cord (108), outside the central unit (100), presents itself in the form of two separate closed systems comprising a left closed circular segment (109) and a right closed circular segment (110), said closed circular segments being adapted to be connected to the animal's front paws.

2. The device of claim 1 wherein the central unit (100) is equipped with a power supply unit (104).

3. The device of claim 1, wherein the central unit (100) is provided with at least a fastening point (106) for the connection with either the harness or the collar.

4. The device of claim 1, further comprising a starting up device (300).

5. The device of claim 1, wherein the left closed circular segment (109) and the right closed circular segment (110) are connected to an elastic dorsal belt (203).

6. The device of claim 1, wherein the actuator (102) is: a motor, a general mechanical, an electromechanical or pneumatic actuator.

7. The device of claim 1, wherein the pulling device (101) is: a pulley, an elastic element, a spring or a pneumatic element.

8. The device of claim 1, wherein the cord (108) is: a wire, a ribbon, a linear element of metallic material or a linear element of non-metallic material.

9. The device of claim 1, wherein the central unit (100) comprises an audio device.
